(19) United States
(12) Patent Application Publication
(10) Pub. No.: US 2009/0172766 A1
(43) Pub. Date: Jul. 2, 2009

(54) BROADCAST RECEIVING APPARATUS AND BROADCAST RECEIVING METHOD

(75) Inventor: Kazuki Kuwahara, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/204,716

(22) Filed: Sep. 4, 2008

(30) Foreign Application Priority Data
Dec. 26, 2007 (JP) 2007-335132

(51) Int. Cl. H04N 7/173

(52) U.S. Cl. 725/131

(57) ABSTRACT

A broadcast receiving apparatus includes: a display module displaying a volume setting menu correspondingly showing volume during reproduction and set volume; an input module inputting the set volume based on the displayed volume setting menu; a generation module generating a table correspondingly showing a broadcast channel, the inputted set volume, and a reproduction start time; and a reproduction module reproducing a broadcast based on the generated table.

### CROSS-REFERENCE TO THE APPLICATIONS

This application is based upon and claims the benefit of priority from the prior Japanese Patent Application No. 2007-335132, filed on Dec. 26, 2007; the entire contents of which are incorporated herein by reference.

### BACKGROUND OF THE INVENTION

1. Field of the Invention

The present invention relates to a broadcast receiving apparatus receiving a broadcast and a broadcast receiving method.

2. Description of the Related Art

A broadcast receiving apparatus receiving a broadcast and viewing a program is used. Here, there is a case when an arrival of time is notified to a user by starting a reproduction of a program at a predetermined time (on-timer). Incidentally, an art is disclosed in which an alarm sound is generated at anon-timer operation time, and this alarm sound is made adjustable (refer to JP-A 03-175815 (KOKAI)).

### BRIEF SUMMARY OF THE INVENTION

Incidentally, when volume at an on-timer operation time is adjusted, it is desirable that the volume can be sensuously recognized. However, it is not always easy to capture the volume sensuously when the volume is displayed on a screen by a numerical value and so on. An object of the present invention is to provide a broadcast receiving apparatus and a broadcast receiving method capable of recognizing reproducing volume at the on-timer operation time more certainly.

A broadcast receiving apparatus according to an aspect of the present invention, includes: a display module displaying a volume setting menu correspondingly showing volume during reproduction and set volume; an input module inputting the set volume based on the displayed volume setting menu; a generation module generating a table correspondingly showing a broadcast channel, the inputted set volume, and a reproduction start time; and a reproduction module reproducing a broadcast based on the generated table.

A broadcast receiving method according to an aspect of the present invention, includes: displaying a volume setting menu correspondingly showing volume during reproduction and set volume; inputting the set volume based on the displayed volume setting menu; generating a table correspondingly showing a broadcast channel, the inputted set volume, and a reproduction start time; and reproducing a broadcast based on the generated table.

### BRIEF DESCRIPTION OF THE DRAWINGS

FIG. 1 is a block diagram showing a broadcast receiving apparatus according to an embodiment of the present invention.

FIG. 2 is a schematic diagram showing an example of an on-timer table T.

FIG. 3 is a flowchart showing an example of an operation procedure of a broadcast receiving apparatus 100.

FIG. 4 is a view showing an example of an on-timer setting menu.

FIG. 5 is a view showing an example of a volume setting menu.

### DETAILED DESCRIPTION OF THE INVENTION

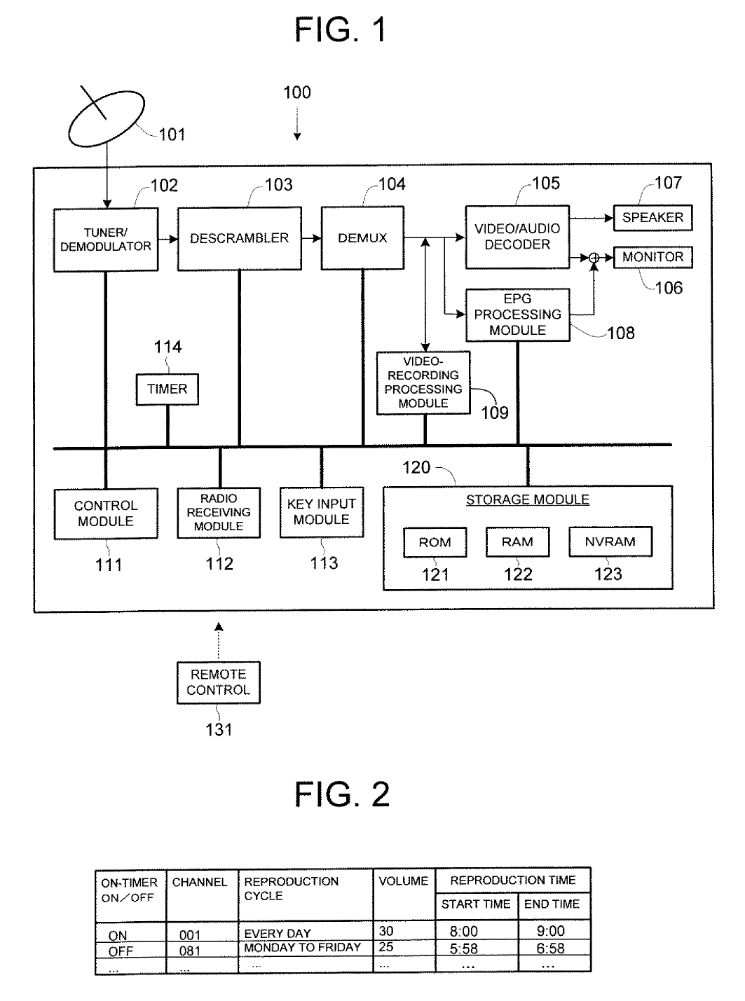

Hereinafter, embodiments of the present invention are described in detail with reference to the drawings. FIG. 1 is a block diagram showing a broadcast receiving apparatus 100 according to an embodiment of the present invention. The broadcast receiving apparatus 100 has an antenna 101, a tuner/demodulator 102, a descrambler 103, a demultiplexing module (DEMUX) 104, a video/audio decoder 105, a monitor 106, a speaker 107, an EPG processing module 108, a video-recording processing module 109, a control module 111, a radio receiving module 112, a key input module 113, a timer 114, and a storage module 120. These modules can be constructed with software by using central processing units or with hardware.

The antenna 101 receives broadcast signals transmitted from a broadcast station. The tuner/demodulator 102 selects a desired channel from the broadcast signals received by the antenna 101, demodulates it, and generates a transport stream (hereinafter, described as a TS). The generated TS is outputted to the descrambler 103. This TS is a multiplexed signal including a scrambled broadcast signal and an SI/PSI. The scrambled broadcast signal is a signal in which, for example, a broadcast signal in MPEG-2 is scrambled.

The SI/PSI is program arrangement information. The SI includes an SDT (Service Definition Table), an EIT (Event Information Table) and soon. The SDT describes detailed information of a service (an organization channel). The EIT describes detailed information of programs within the service. An EPG (Electronic Program Guide) is created by mainly using the EIT. The PSI describes a constitution and so on of multiplexed plural programs, and includes a PAT (Program Association Table), a PMT (Program Map Table) and so on.

The descrambler 103 descrambles the TS inputted from the tuner/demodulator 102 to output to the demultiplexing module 104. Namely, the scrambled broadcast signal within the TS is descrambled and the broadcast signal is generated.

The demultiplexing module 104 demultiplexes the broadcast signal, the SI/PSI data and so on from the TS inputted from the descrambler 103. Besides, the demultiplexing module 104 outputs the demultiplexed broadcast signal to the video/audio decoder 105.

The video/audio decoder 105 decodes the broadcast signal inputted from the demultiplexing module 104, to output to the monitor 106 and the speaker 107. The monitor 106 is a display device such as a CRT and a liquid crystal display device. The speaker 107 is an audio output device.

The EPG processing module 108 constitutes EPG (Electronic Program Guide) information from the SI data demultiplexed by the demultiplexing module 104, and further, generates an image signal of the EPG. The EPG is displayed on the monitor 106 by the image signal. A user can confirm and reserve a program by using the EPG.

The video-recording processing module 109 video-records and reproduces a broadcast by using the broadcast signal outputted from the demultiplexing module 104. The EPG can be used for the reservation of the video-recording.

The control module 111 is constituted by a CPU (Central Processing Unit), and controls the whole of the broadcast receiving apparatus 100. The control module 111 performs the following processes.

### (1) Setting of On-Timer

The control module 111 sets an on-timer. Namely, the control module 111 controls displays of various screens for an on-timer process, inputs and so on from a remote control 131 and soon. Information for the on-timer process is inputted. The control module 111 generates an on-timer table T in which the information for the on-timer process is summarized, and stores it to an NVRAM 123.

FIG. 2 is a schematic diagram showing an example of the on-timer table T. An ON/OFF of on-timer, a channel, a reproduction cycle, volume, and a reproduction time are correspondingly shown.

The “ON/OFF of on-timer” represents whether the on-timer is used or not. When this field is OFF, an on-timer operation is stopped.

The “channel” represents a channel at the on-timer operation time.

The “reproduction cycle” represents a cycle of the on-timer operation. For example, “every day”, “Monday to Friday”, “every week” can be selected.

The “volume” represents largeness of a reproduced sound at the on-timer operation time. As it is described later, a volume setting menu display is used to set this “volume”.

The “reproduction time” shows a reproduction start time and a reproduction end time at the time of on-timer.

### (2) On-Timer Process

The control module 111 performs the on-timer process. Namely, the control module 111 activates the broadcast receiving apparatus 100 and reproduces the broadcast in accordance with the on-timer table T.

The radio receiving module 112 receives user operational information transmitted from the remote control 131 in radio (for example, an infrared ray). The remote control 131 has a “cursor” button, a “blue” button, a “red” button, a “volume” button, a “mute” button, a “decision” button, and a “return” button, and an input of the user operational information is possible. Incidentally, process contents when these buttons are operated are described later.

The key input module 113 is an input device, for example, a keyboard inputting the user operational information. The key input module 113 has a “cursor” button, a “blue” button, a “red” button, a “volume” button, a “mute” button, a “decision” button, and a “return” button, and the input of the user operational information is possible as same as the remote control 131.

The timer 114 shows a current time, and it is used for the on-timer process.

The storage module 120 is constituted by a ROM (Read Only Memory) 121, a RAM (Random Access Memory) 122, and the NVRAM (Non Volatile RAM) 123. The ROM 121 stores programs and so on to operate the control module 111. The RAM 122 is used at the operation time of the control module 111, and programs, data and so on are written thereto. The NVRAM 123 stores the on-timer table T.

### (Operations of Broadcast Receiving Apparatus 100)

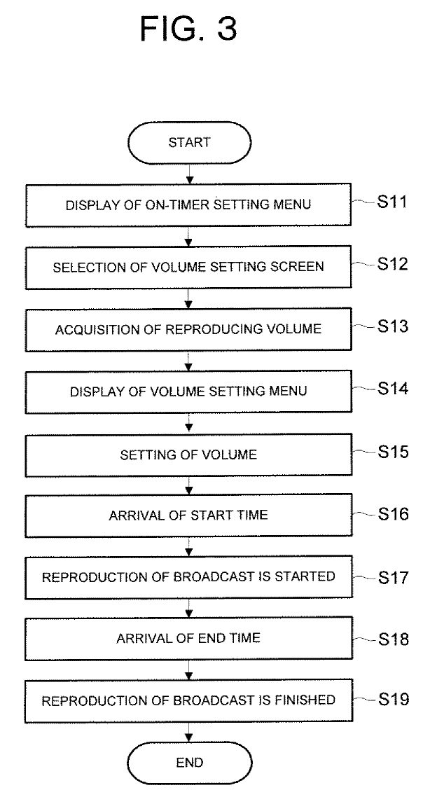

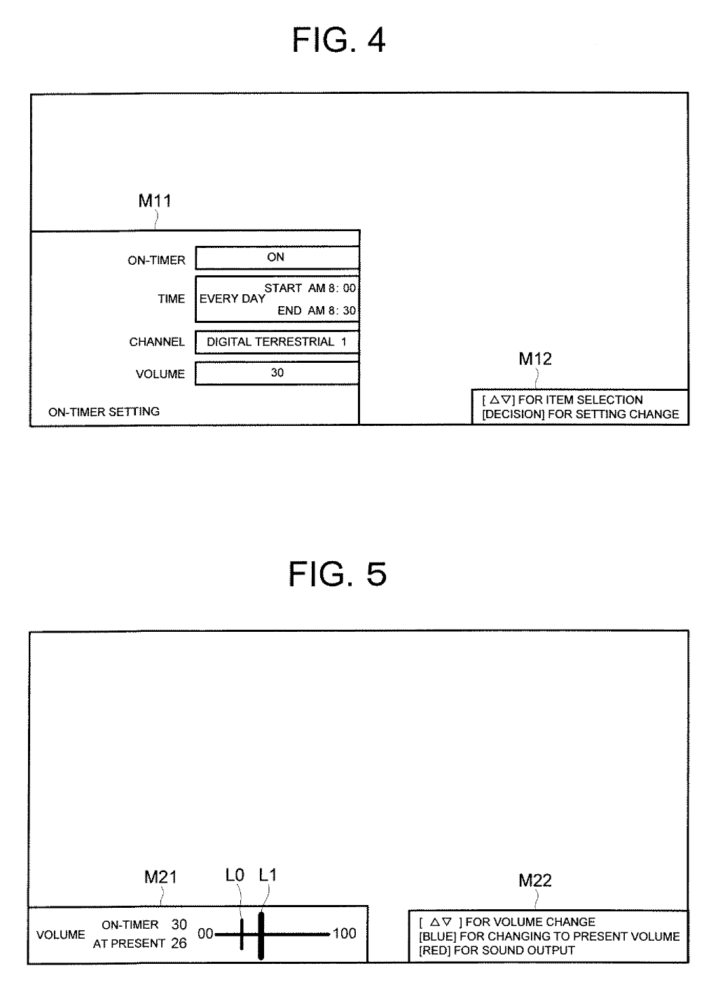

Hereinafter, an operation procedure of the broadcast receiving apparatus 100 is described. FIG. 3 is a flowchart showing an example of the operation procedure of the broadcast receiving apparatus 100. FIG. 4 and FIG. 5 are views showing menus displayed on the monitor 106 at the on-timer setting time.

### A. Setting of On-Timer (Steps S11 to S15)

### (1) Display of On-Timer Setting Menu (Step S11)

The user operates the remote control 131, and thereby, the on-timer setting menu is displayed on the monitor 106.

FIG. 4 is the view showing an example of the on-timer setting menu. An on-timer setting menu M11 and a descriptive text M12 are displayed on the screen of the monitor 106. A switching button of the “on-timer” ON/OFF, a “time” setting button, a “channel” setting button, and a “volume” setting button are displayed on the on-timer setting menu M11.

The switching button of the “on-timer” ON/OFF is a button to input information to switch whether the on-timer is executed or not (ON/OFF).

The “time” setting button is a button to input information of the reproduction cycle and the reproduction time (start time, end time).

The “channel” setting button is a button to input information to select the channel to be reproduced at the on-timer process time.

The “volume” setting button is a button to display a volume setting menu.

### (2) Display of Volume Setting Menu (Steps S12 to S14)

The “volume” setting button is selected by operating the “cursor” button of the remote control 131, and the “decision” button of the remote control 131 is pressed in the on-timer setting menu. As a result, the screen moves to the volume setting menu. At this time, the control module 111 acquires information of the volume which is being reproduced at present by the speaker 107.

FIG. 5 is the view showing an example of the volume setting menu. A volume setting menu M21 and a descriptive text M22 are displayed on the screen of the monitor 106.

Level bars L1, L0 are displayed on the volume setting menu M21. The level bar L1 is a level bar for a volume setting at the on-timer operation time. The level bar L0 is a level bar showing the volume during reproduction. The volumes at the time of on-timer and at present are shown by positions of the level bars L1, L0 between “00” to “100” on the volume setting menu. Besides, the volumes are also shown by the numerical values in addition to the level bar displays (volume at the time of on-timer: 30, volume at present: 26). As stated above, it is possible to comprehend the volume at the on-timer operation time more appropriately by displaying the volume at the time of on-timer and the volume at present simultaneously.

### (3) Setting of Volume (Step S15)

The user can set the volume as stated below by operating the remote control 131 and so on. The level bar L1 of a set volume of the volume setting menu moves by operating the “cursor” button, and the numerical value of a volume level increases/decreases. The set volume level becomes the same as the volume level during reproduction by pressing the “blue” button. A sound is temporary outputted at the set volume level by pressing the “red” button. A present viewing volume level within the setting screen increases/decreases with corresponding to the set volume level by pressing the “volume” button. The present viewing volume level bar is tone-down displayed by pressing the “mute” button, and the “mute” is displayed at the numerical value. The set contents are stored by pressing the “decision” button. The screen moves to a setting menu screen at an upper hierarchy from the volume setting menu by pressing the “return” button.

The on-timer table T is created or on-timer information is added to the existing on-timer table T based on the set volume (refer to FIG. 2). The ON/OFF of on-timer, the channel, the reproduction cycle, the volume and the reproduction time are added to the on-timer table T.

### B. On-Timer Process (Steps S16 to S19)

The on-timer process is performed based on the on-timer table T. Namely, a reproduction of a program is started with the set channel and volume when the reproduction start time arrives (steps S16, S17). The reproduction of the broadcast is finished when the reproduction end time arrives (steps S18, S19).

As stated above, the present viewing volume is displayed by the numerical value and the bar when the user sets the volume at an on-timer reproduction time. As a result, it becomes easy to comprehend the set volume level at the on-timer operation time. Besides, it is possible to output the sound corresponding to the set volume even at the display time of the volume setting menu, and to confirm the volume by pressing the “red” button.

### Other Embodiments

Embodiments of the present invention are not limited to the above-stated embodiments, and can be expanded/modified without departing from the spirit or essential characteristics thereof, and such expanded/modified embodiments are also included in the technical scope of the present invention.

What is claimed is:

1. A broadcast receiving apparatus, comprising:
a display module displaying a volume setting menu correspondingly showing volume during reproduction and set volume;
an input module inputting the set volume based on the displayed volume setting menu;
a generation module generating a table correspondingly showing a broadcast channel, the inputted set volume, and a reproduction start time; and
a reproduction module reproducing a broadcast based on the generated table.

2. The broadcast receiving apparatus according to claim 1,
wherein the volume setting menu represents the volume during reproduction and the set volume by both level bars and numerical values.

3. The broadcast receiving apparatus according to claim 1, further comprising a second input module inputting information to make the set volume match with the volume during reproduction.

4. The broadcast receiving apparatus according to claim 1, further comprising a third input module inputting information to output a sound corresponding to the set volume.

5. A broadcast receiving method, comprising:
displaying a volume setting menu correspondingly showing volume during reproduction and set volume;
inputting the set volume based on the displayed volume setting menu;
generating a table correspondingly showing a broadcast channel, the inputted set volume, and a reproduction start time; and
reproducing a broadcast based on the generated table.

6. The broadcast receiving method according to claim 5,
wherein the volume setting menu represents the volume during reproduction and the set volume by both level bars and numerical values.

7. The broadcast receiving method according to claim 5, further comprising inputting information to make the set volume match with the volume during reproduction.

8. The broadcast receiving method according to claim 5, further comprising inputting information to output a sound corresponding to the set volume.
